(19) United States
(12) Patent Application Publication
(10) Pub. No.: US 2011/0167163 A1
(43) Pub. Date: Jul. 7, 2011

(54) COMMUNICATION SYSTEM, METHOD, DEVICE AND PROGRAM

(76) Inventors: Kamame Naito, Tokyo (JP); Katsuhiro Ochiai, Tokyo (JP); Shuhei Miura, Tokyo (JP); Junichi Gokurakuji, Tokyo (JP); Motonobu Kimura, Tokyo (JP)

(21) Appl. No.: 12/674,222

(22) PCT Filed: Oct. 3, 2008
(86) PCT No.: PCT/JP2008/068042

§ 371 Date: Feb. 19, 2010

(30) Foreign Application Priority Data
Oct. 16, 2007 (JP) 2007-268851

(51) Int. Cl. G06F 15/16

(52) U.S. Cl. 709/228

(57) ABSTRACT

A first communication apparatus executes a session control protocol thereby to determine a session identifier which identifies a session for media-related protocols for transferring the data when the session is established, and thereafter executes the media-related protocols thereby to perform communications for transferring the data on the session. A second communication apparatus executes the session control protocol thereby to establish a session for the media-related protocols with the first communication apparatus, and thereafter executes the media-related protocol thereby to perform communications for transferring the data with the first communication apparatus on the session.

### TECHNICAL FIELD

The present invention relates to a media distribution technology based on a quality assurance network.

### BACKGROUND ART

Quality assurance networks typified by NGN (Next Generation Network) perform control processes with respect to the quality of sessions (QoS (Quality of Service)) according to session control protocols typified by SIP (Session Initiation Protocol: see RFC3261—SIP: Session Initiation Protocol, June 2002). The control processes with respect to quality include a band control process and a priority control process which are associated with authentication.

The quality of communications is related to the quality of services such as video reproduction quality and the charging of fees for communications. If the quality of communications is high, then the quality of services provided to users is high and the fees charged to users is also high.

Heretofore, quality assurance networks have mostly been used for telephone services for two-way calls. According to such telephone services, the transmission and reception of two-way media is realized in one session.

However, it is also conceivable to use quality assurance networks for video distribution services. A video distribution service is a service for distributing video data from a distribution server which stores video data in the receivers of users for allowing the receivers to reproduce video images. The video distribution services are realized according to a media control protocol and a media distribution protocol. Therefore, a session control protocol controls a plurality of sessions in order to realize one service.

FIG. 1 is a block diagram showing the configuration of a communication system for distributing video data through a quality assurance network. As shown in FIG. 1, the communication system includes distribution server 91 and receiver 92. Distribution server 91 and receiver 92 are connected to each other through quality assurance network 93. For example, receiver 92 sends a request for the distribution of video data to communication server 91, and communication server 91 distributes video data to receiver 92 in response to the request. The distribution of video data is realized according to a media control protocol typified by RTSP (Real Time Streaming Protocol) and a media distribution protocol typified by RTP (Real Time Transport Protocol).

The media control protocol is a protocol for controlling the states of video distribution including reproduction, stop, and recording of video data. RTSP, which is a typical example of the media control protocol, is generally implemented in TCP (Transmission Control Protocol).

The media distribution protocol is a protocol for actually transferring video data. RTP, which is a typical example of the media distribution protocol, is generally implemented in UDP (User Datagram Protocol).

The media control protocol, the media distribution protocol, and the session control protocol for controlling sessions thereof are implemented in distribution server 92 and receiver 91. The session control protocol controls sessions for assuring the quality of communications according to the media control protocol and the media distribution protocol. For example, the session control protocol may perform a priority control process for the media control protocol and a band allocation control process for the media distribution protocol.

### DISCLOSURE OF THE INVENTION

According to a sequence for starting these protocols, the session control protocol is initially started to indicate a session description to quality assurance network 93. After it has become possible to control the session, protocols to be controlled by the session control protocol are started. In the above example of the video distribution service, the protocols to be controlled by the session control protocol are the media control protocol and the media distribution protocol.

Of the protocols to be controlled by the session control protocol, the media control protocol is implemented in TCP as described above. According to TCP, a transmission source port number is determined when a TCP handshake is initiated. Thereafter, until a TCP handshake is initiated, the session for the media control protocol cannot be specified by a port number, and the session control protocol is unable to control quality settings, etc. for the session for the media control protocol.

It is an object of the present invention to provide a communication system, method, apparatus, and program which are capable of starting a media control protocol with appropriate quality settings.

To achieve the above object, there is provided in accordance with an aspect of the present invention a communication system for transferring data through a quality assurance network which is capable of making quality settings for each session, comprising:

a first communication apparatus for executing a session control protocol thereby to determine a session identifier which identifies a session for media-related protocols for transferring said data when the session is established, and thereafter executing said media-related protocols thereby to perform communications for transferring said data on said session; and

a second communication apparatus for executing said session control protocol thereby to establish a session for said media-related protocols with said first communication apparatus, and thereafter executing said media-related protocol thereby to perform communications for transferring said data with said first communication apparatus on said session.

According to another aspect of the present invention, there is provided a communication method in a communication system for transferring data through a quality assurance network which is capable of making quality settings for each session, comprising:

executing a session control protocol thereby to determine a session identifier which identifies a session for media-related protocols for transferring said data when the session is established; and

thereafter executing said media-related protocols thereby to perform communications for transferring said data on said session.

According to still another aspect of the present invention, there is provided a

communication apparatus for sending or receiving data in a communication system for transferring said data through a quality assurance network which is capable of making quality settings for each session, comprising:

session control protocol executing means for executing a session control protocol thereby to determine a session identifier which identifies a session for media-related protocols for transferring said data when the session is established; and

media-related protocols executing means for executing said media-related protocols after said session control protocol executing means has determined said session identifier, thereby to perform communications for transferring said data on said session.

According to yet another aspect of the present invention, there is provided a

program for operating a computer as a communication apparatus for sending or receiving data in a communication system for transferring said data through a quality assurance network which is capable of making quality settings for each session, said program enabling said computer to execute:

a sequence for executing a session control protocol thereby to determine a session identifier which identifies a session for media-related protocols for transferring said data when the session is established; and

a sequence for thereafter executing said media-related protocols thereby to perform communications for transferring said data on said session.

### BRIEF DESCRIPTION OF THE DRAWINGS

FIG. 1 is a block diagram showing the configuration of a communication system for distributing video data through a quality assurance network;

FIG. 2 is a block diagram showing the configuration of a communication system according to an exemplary embodiment of the present invention;

FIG. 3 is a sequence diagram showing an operation sequence for starting the distribution of video data in the communication system according to the exemplary embodiment;

FIG. 4 is a block diagram showing the configuration of a distribution server according to the exemplary embodiment;

FIG. 5 is a block diagram showing the configuration of a receiver according to the exemplary embodiment;

FIG. 6 is a sequence diagram showing an operation sequence of a communication system according to a first example;

FIG. 7 is a sequence diagram showing an operation sequence of a communication system according to a second example;

FIG. 8 is a sequence diagram showing an operation sequence of a communication system according to a third example;

FIG. 9 is a sequence diagram showing an operation sequence of a communication system according to a fourth example;

FIG. 10 is a sequence diagram showing an operation sequence of a communication system according to a fifth example; and

FIG. 11 is a sequence diagram showing an operation sequence of a communication system according to a sixth example.

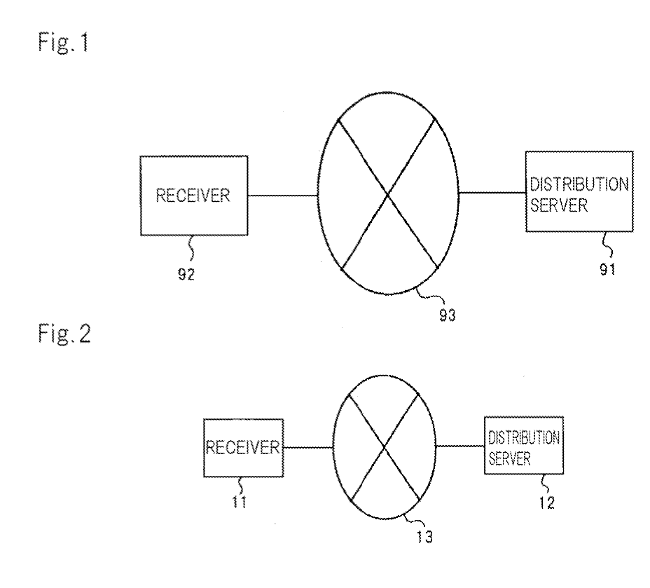

### BEST MODE FOR CARRYING OUT THE INVENTION

An exemplary embodiment of the present invention will be described in detail with reference to the drawings.

FIG. 2 is a block diagram showing the configuration of a communication system according to an exemplary embodiment of the present invention. As shown in FIG. 2, the communication system includes distribution server 11 and receiver 12. Distribution server 11 and receiver 12 are connected to each other through quality assurance network 13. Quality assurance network 13 is a network for setting a band and priority to be allocated for communications and assuring quality settings that have been made.

Receiver 12 sends a request for the distribution of video data through quality distribution network 13 to communication server 11, and communication server 11 distributes video data through quality distribution network 13 to receiver 12 in response to the request. At this time, quality settings made for communications between receiver 12 and distribution server 11 are assured by quality distribution network 13.

Such a video distribution service is realized by two protocols related to the distribution of media, i.e., a media control protocol typified by RTSP and a media distribution protocol typified by RTP. Sessions are established respectively for the protocols, and it is possible to make quality settings for each of the sessions.

The media control protocol, the media distribution protocol, and a session control protocol typified by SIP for controlling sessions thereof are implemented in distribution server 12 and receiver 11.

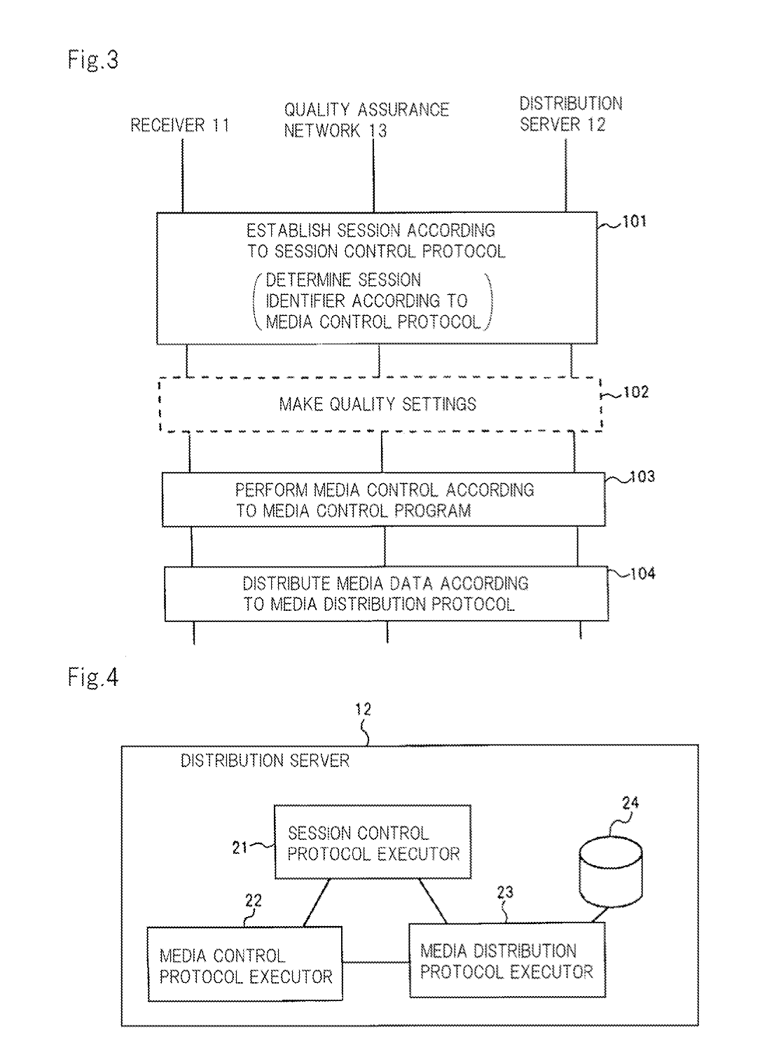

FIG. 3 is a sequence diagram showing an operation sequence for starting the distribution of video data in the communication system according to the exemplary embodiment. When the distribution of video data is started, distribution server 12 and receiver 11 initially start the execution of the session control protocol. Distribution server 12 and receiver 11 establish a session for the media control protocol and a session for the media distribution protocol according to the session control protocol (step 101). At this time, the session control protocol determines a session identifier for specifying the session for the media control protocol.

When the session identifier for the media control protocol is determined, it has become possible to control the session with the specified media control protocol. Distribution server 12 and receiver 11 may then perform a control process for making quality settings such as a priority control process for the session for the media control protocol, as part of the process of establishing the session or after the establishment of the session, before the media control process is initiated (step 102). With the priority of the media control protocol being appropriately set, it is possible to keep responsiveness in the execution of media control from the start of the media control protocol.

Since the media distribution protocol is implemented in UDP according to the present exemplary embodiment, it is assumed that a session can be specified by a port number prior to the start of the media control protocol. Therefore, even if the session control protocol does not determine a session identifier for the media distribution protocol, it is possible to perform a control process with the session for the media distribution protocol being specified. Distribution server 12 and receiver 11 may then make appropriate quality settings such as a band allocated for the media distribution protocol.

Subsequently, distribution server 12 and receiver 11 perform media control according to the media control protocol based on a command action made on receiver 11 by the user (step 103). Based on the media control, video data are distributed from distribution server 12 to receiver 11 according to the media distribution protocol (step 104). Receiver 11 reproduces the video data received from distribution server 12.

FIG. 4 is a block diagram showing the configuration of a distribution server according to the exemplary embodiment. As shown in FIG. 4, distribution server 12 comprises session control protocol executor 21, media control protocol executor 22, media distribution protocol executor 23, and media storage 24.

Session control protocol executor 21 executes a session control protocol which is typified by SIP thereby to establish, change, and cut off a session for a protocol to be controlled. For video distribution services, there are available a media control protocol which is typified by RTSP and a media distribution protocol which is typified by RTP, as protocols to be controlled by the session control protocol.

Quality settings are made for the established session, and communications are performed on the session according to the quality settings. The quality settings made for the session include a priority and an allocated band. These quality settings are alterable.

It is assumed according to the media control protocol that the responsiveness for starting and stopping video reproduction depends on the priority setting. It is assumed according to the media distribution protocol that the quality of reproduced video data depends on the setting of the allocated band.

When a session is established, session control protocol executor 21 determines a session identifier for specifying a session for the media control protocol in cooperation with receiver 11. Using the determined session identifier, session control protocol executor 21 may specify the media control protocol thereby to cooperate with receiver 11 and perform a control process for making appropriate quality settings for the session for the media control protocol.

Media control protocol executor 22 executes the media control protocol thereby to perform a media control process for reproducing and stopping video data in cooperation with receiver 11. The media control protocol performs communications with receiver 11 for the media control process according to the quality settings made by the session control protocol.

Media distribution protocol executor 23 executes the media distribution protocol to distribute video data stored in media storage 24 to receiver 11 according to the media control process performed by media control protocol executor 22. The media distribution protocol carries out the media distribution according to the quality settings made by the session control protocol.

Media storage 24 stores media data to be distributed to receiver 11.

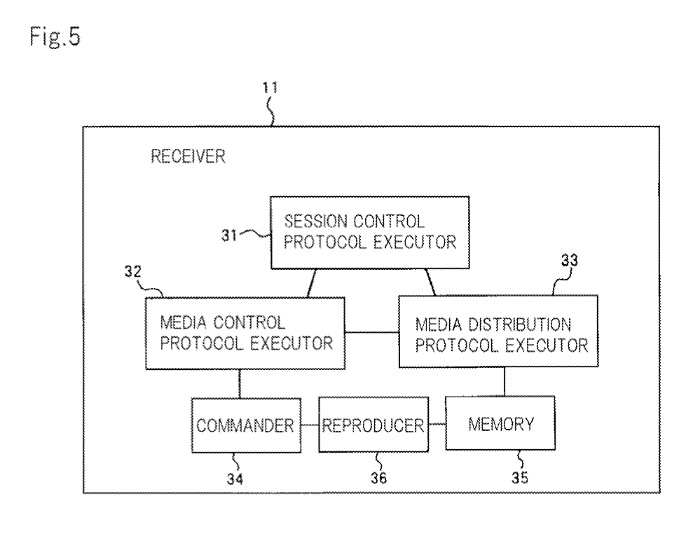

FIG. 5 is a block diagram showing the configuration of the receiver according to the exemplary embodiment. As shown in FIG. 5, receiver 11 comprises session control protocol executor 31, media control protocol executor 32, and media distribution protocol executor 33. In this example, it is assumed that receiver 11 has its own commander 34, memory 35, and reproducer 36 of its own. However, one or more of commander 34, memory 35, and reproducer 36 may be provided in a device different from receiver 11.

Session control protocol executor 31 executes the session control protocol thereby to establish, change, and cut off sessions for the media control protocol and the media distribution protocol for video distribution services. Quality settings are made for the established sessions.

When a session is established, session control protocol executor 31 determines a session identifier for specifying a session for the media control protocol in cooperation with distribution server 12. Using the determined session identifier, session control protocol executor 31 may specify the media control protocol thereby to cooperate with receiver 11 and perform a control process for making appropriate quality settings for the session for the media control protocol.

Media control protocol executor 32 executes the media control protocol thereby to perform a media control process for reproducing and stopping video data in cooperation with distribution server 12. Media control protocol executor 32 reproduces and stops video data based on a command action made on commander 34 by the user. The media control protocol performs communications with distribution server 12 for the media control process according to the quality settings made by the session control protocol.

Media distribution protocol executor 33 executes the media distribution protocol to receive video data distributed from distribution server 12 according to the media control process performed by media control protocol executor 22. The received data are first recorded in memory 35 and then reproduced by reproducer 36. The media distribution protocol carries out the media distribution according to the quality settings made by the session control protocol.

Commander 34 receives a command action from the user and sends the content of the command action to various parts. For example, session control protocol executor 31 may be activated to establish and cut a session by a command action from the user. Media control protocol executor 32 may be activated to start and stop reproducing video data by a command action from the user.

Memory 35 stores video data received by media distribution protocol executor 33. Reproducer 36 reproduced video data stored in memory 35.

According to the present exemplary embodiment, as described above, when the session control protocol establishes a session, it determines a session identifier for specifying a session for the media control protocol. Therefore, before the media control protocol itself is initiated, it is possible to perform a quality control process for the session for the media control protocol, and hence to keep appropriate quality from the start of the media control protocol. Furthermore, since there is no need to add special processing and functions to quality assurance network 13 in reducing the present exemplary embodiment to practice, a general quality assurance network can be used according to the present exemplary embodiment.

According to the present exemplary embodiment, when the session control protocol establishes a session, it determines a session identifier for specifying a session for the media control protocol. At this time, a session identifier may be determined by an exchange of session information including a session identifier between distribution server 12 and receiver 11. For example, distribution server 12 may determine a session identifier and indicate the determined session identifier to receiver 11. Alternatively, receiver 11 may determine a session identifier and indicate the determined session identifier to distribution server 12. Further alternatively, distribution server 12 and receiver 11 may select a session identifier which can be used by both of them while distribution server 12 and receiver 11 are confirming each other. The determined session identifier for the media control protocol may be managed by either one, some, or all of distribution server 11, receiver 12, and a session control server (not shown) in quality assurance network 13.

In the present exemplary embodiment, when a session identifier is determined, distribution server 12 and receiver 11 may determine session information required for the media control process when a session identifier is determined, and may dispense with the determination of session information at the time of starting the media control protocol. This is effective to simplify the sequence at the time of starting the video distribution service.

Generally, the media control protocol is brought into a state capable of reproducing video data by moving from an initial state to a standby state. For example, RTSP transits through four states “Initial”, “Ready”, “Playing”, and “Recording” when triggered by operation of the media control process. When the media control process moves through the state “Initial” to the state “Ready”, it becomes possible to reproduce video data.

However, if a session identifier and other session information are determined when a session is established, as described above, then the media control protocol may be brought into a standby state capable of reproducing video data without moving through an initial state when triggered by the establishment of the session by the session control protocol. For example, RTSP may be brought into a state capable of reproducing video data by moving to the state “Ready” without moving through the state “Initial”.

In that case, furthermore, the media control process may not have an initial state, and may release state management and be finished without going through an initial state when triggered by the cutting off of the session by the session control protocol.

According to the present exemplary embodiment, since the media distribution protocol can specify a session based on a pair of a transmission source/destination IP address and a transmission source/destination port number, the session control protocol determines only a session identifier for the media control protocol and does not determine a session identifier for the media distribution protocol when a session is established. However, the present invention is not limited to such an example. According to another example, the session control protocol may determine both a session identifier for the media control protocol and a session identifier for the media distribution protocol when a session is established. With this example, even if a dynamically selected port, not a default port, is used in the media distribution protocol, the media distribution protocol is able to perform a session control process for allocating a band for media distribution immediately after the session is established.

According to the present exemplary embodiment, furthermore, the video distribution service is realized by the media control protocol and the media distribution protocol. However, the present invention is not limited to such an example. According to another example, one or both of an error correcting protocol and a QoS report protocol may also be used for the realization of the video distribution service. In that case, the session control protocol also controls a session for the error correcting protocol and a session for the QoS report protocol. Therefore, when a session is established, the session control protocol may also determine session identifiers of one or both sessions for the error correcting protocol and the QoS report protocol.

According to the present exemplary embodiment, furthermore, it is assumed that distribution server 12 comprises a physically single apparatus. However, the present invention is not limited to such an example. According to another example, distribution server 12 may have session control protocol executor 21, media control protocol executor 22, media distribution protocol executor 23 decentrally provided in a plurality of apparatus.

According to the present exemplary embodiment, moreover, it is assumed that receiver 11 comprises a physically single apparatus. However, the present invention is not limited to such an example. According to another example, receiver 11 may have session control protocol executor 31, media control protocol executor 32, and media distribution protocol executor 33 decentrally provided in a plurality of apparatus. Similarly, distribution server 12 may have session control protocol executor 21, media control protocol executor 22, media distribution protocol executor 23 decentrally provided in a plurality of apparatuses.

According to the present exemplary embodiment, moreover, it is assumed that video data are distributed by way of unicast transmission. However, the present invention is not limited to such an example. For distributing video data by way of multicast transmission from one distribution server 12 to a plurality of receivers 11, a session identifier may be determined when a session is established.

### First Example

According to a first example, it is assumed that SIP is used as the session control protocol, RTSP as the media control protocol, and RTP as the media distribution protocol. According to the first example, it is also assumed that distribution server 12 determines a session identifier for the media control protocol.

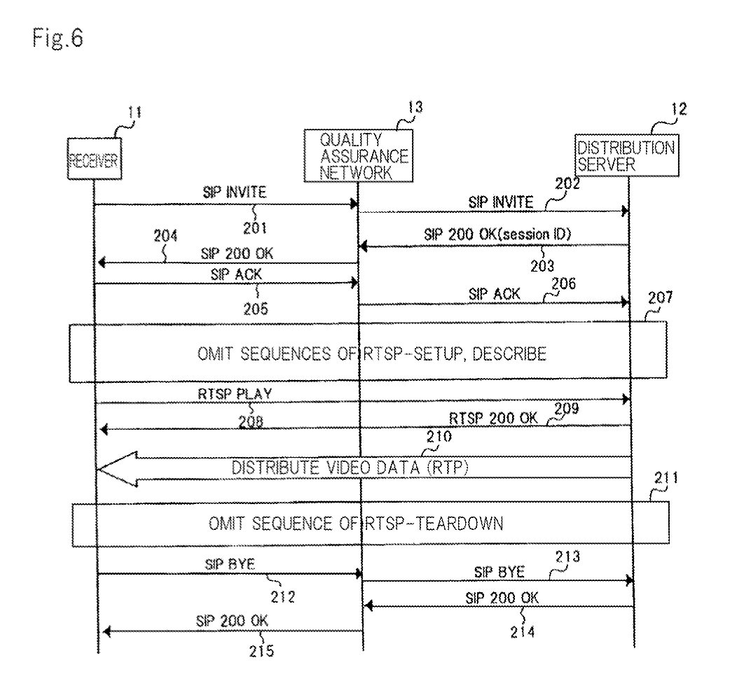

FIG. 6 is a sequence diagram showing an operation sequence of a communication system according to the first example. As shown in FIG. 6, when receiver 11 sends an “SIP INVITE” message requesting the establishment of a session to quality assurance network 13 (step 201), quality assurance network 13 sends the “SIP INVITE” message to distribution server 12 (step 202).

Distribution server 12 which has received the “SIP INVITE” message returns an “SIP 200 OK” message indicating the acceptance of a request for starting a session to quality assurance network 13 (step 203). According to the present example, as described above, distribution server 12 determines a session identifier for RTSP. The session identifier for RTSP (session ID in FIG. 6) determined by distribution server 12 is inserted in SIP-SDP (Session Description Protocol) of the “SIP 200 OK” message.

Having received the “SIP 200 OK” message, quality assurance network 13 sends the “SIP 200 OK” message to receiver 11 (step s04). According to this example, session information including the session identifier for the media control protocol is also inserted in SIP-SDP of the “SIP 200 OK” message. Thus, receiver 11 is also capable of specifying the session for the media control protocol. However, if receiver 11 does not need to specify the session identifier for the media control protocol in the session control process, then the session identifier for the media control protocol may not be inserted in the “SIP 200 OK” message sent from quality assurance network 13 to receiver 11.

Having received the “SIP 200 OK” message, receiver 11 sends an “SIP ACK” message acknowledging the establishment of the session to quality assurance network 13 (step 205), which sends the “SIP ACK” message to distribution server 12 (step 206).

In the present example, it is assumed that the session information including the session identifier for RTSP is inserted in the “SIP 200 OK” message in step 203. The session for RTSP is started because the session information is inserted in SIP-SDP. As a result, since an appropriate band is allocated to the session and an appropriate priority is set in the session, sequences of SETUP and DESCRIBE are omitted in RTSP (step 2079>

With SETUP and DESCRIBE being omitted, RTSP is brought into the state “Ready” capable of immediately reproducing video data. In the example shown in FIG. 6, receiver 11 sends an “RTSP PLAY” message to distribution server 12, thereby sending a request for the reproduction of video data (step 208). Having received the “RTSP PLAY” message, distribution server 12 returns an “RTSP 200 OK” message indicating acceptance of the request to receiver 11 (step 209), and distributes video data to receiver 11 according to RTP (step 201). Receiver 11 which has received the video data first stores the video data in memory 35 and then reproduces the video data with reproducer 36.

In the present example, the session is released without moving from the state “Ready” through the state “Initial”. Therefore, the sequence of RTSP-TEARDOWN is omitted (step 211). However, the present invention is not limited to such an example, but the session may be released by moving from the state “Ready” through the state “Initial” according to the general state transition.

When receiver 11 sends an “SIP BYE” message requesting the cutting off of the session to quality assurance network 13 (step 212), quality assurance network 13 sends the “SIP BYE” message to distribution server 12 (step 213).

Having received the “SIP BYE” message, distribution server 12 sends an “SIP 200 OK” message indicating acceptance of the request for cutting off the session to quality assurance network 13 (step 214), which then sends the “SIP 200 OK” message to receiver 12 (step 215). The session is not cut off, and the communications are finished.

### Second Example

According to a second example, as with the first example, it is assumed that SIP is used as the session control protocol, RTSP as the media control protocol, and RTP as the media distribution protocol. According to the second example, however, unlike the first example, receiver 11 determines a session identifier for the media control protocol.

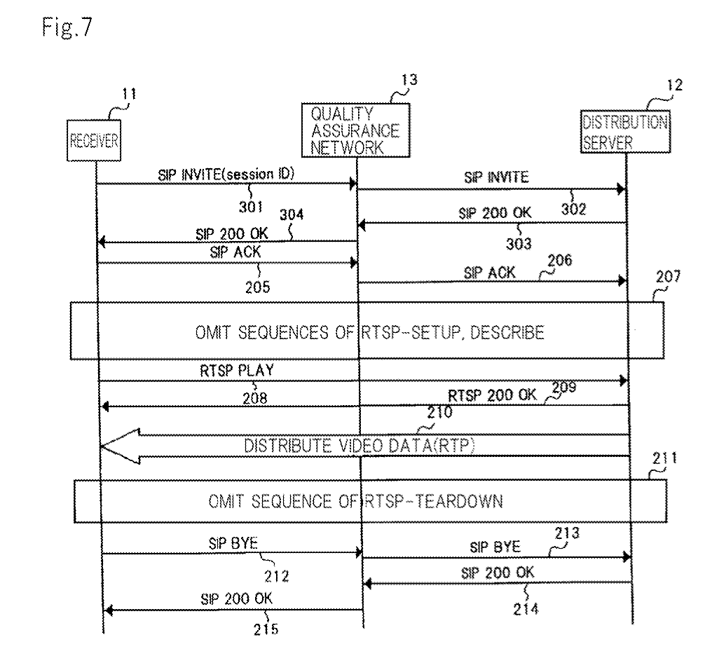

FIG. 7 is a sequence diagram showing an operation sequence of a communication system according to a second example. According to the second example, as with the first example, receiver 11 sends an “SIP INVITE” message requesting the establishment of a session to quality assurance network 13 (step 301). However, the session information including the session identifier (session ID) for the media control protocol, which is inserted in the “SIP 200 OK” message in step 203 according to the first example shown in FIG. 6, is inserted in the “SIP INVITE” message according to the present example.

Then, quality assurance network 13 sends an “SIP INVITE” message to distribution server 12 (step 302). According to the present example, the session information including the session identifier for the media control protocol is also inserted in SIP-SDP of the “SIP INVITE” message. Thus, distribution server 12 is also capable of specifying the session for the media control protocol.

Distribution server 12 which has received the “SIP INVITE” message returns an “SIP 200 OK” message indicating acceptance of a request for starting a session to quality assurance network 13 (step 303). According to the present example, the session identifier for the media control protocol may not be inserted in the “SIP 200 OK” message. Having received the “SIP 200 OK” message, quality assurance network 13 sends the “SIP 200 OK” message to receiver 11 (step 304). Subsequently, the operation sequence is identical to the operation sequence according to the first example shown in FIG. 6 (steps 205 through 215).

### Third Example

According to a third example, as with the first example, it is assumed that SIP is used as the session control protocol, RTSP as the media control protocol, and RTP as the media distribution protocol. According to the third example, as with the first example, it is also assumed that distribution server 12 determines a session identifier for the media control protocol. According to the third example, however, unlike the second example, the session information including the session identifier for the media control protocol is indicated by an “SIP 183 session progress” message.

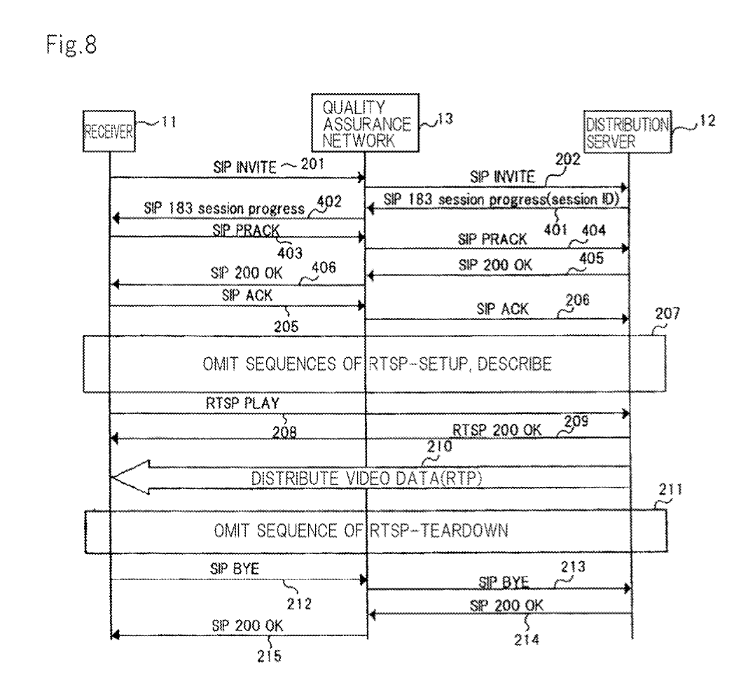

FIG. 8 is a sequence diagram showing an operation sequence of a communication system according to the third example. When receiver 11 sends an “SIP INVITE” message requesting the establishment of a session to quality assurance network 13 (step 201), quality assurance network 13 sends the “SIP INVITE” message to distribution server 12 (step 202).

Distribution server 12 which has received the “SIP INVITE” message sends an “SIP 183 session progress” message as a tentative response to quality assurance network 13 (step 401). The session information including the session identifier for the media control protocol, which has been determined by distribution server 12, is inserted in SIP-SDP of the “SIP 183 session progress” message. The session information of the media control protocol is thus indicated to quality assurance network 13.

Having received the “SIP 183 session progress” message, quality assurance network 13 sends the “SIP 183 session progress” message to receiver 11 (step 402).

Having received the “SIP 183 session progress” message, receiver 11 returns an “SIP PRACK” message acknowledging the tentative response to quality assurance network 13 (step 403). Quality assurance network 13 which has received the “SIP PRACK” message sends the “SIP PRACK” message to distribution server 12 (step 404).

Distribution server 12 which has received the “SIP PRACK” message returns an “SIP 200 OK” message indicating that it will finally accept a request for starting a session to quality assurance network 13 (step 405). Having received the “SIP 200 OK” message, quality assurance network 13 sends the “SIP 200 OK” message to receiver 11 (step 406). Subsequently, the operation sequence is identical to the operation sequence according to the first example shown in FIG. 6 (steps 205 through 215).

### Fourth Example

According to a fourth example, as with the first example, it is assumed that SIP is used as the session control protocol, RTSP as the media control protocol, and RTP as the media distribution protocol. According to the fourth example, as with the second example, it is also assumed that distribution server 12 determines a session identifier for the media control protocol. According to the fourth example, as with the third example, distribution server 12 sends an “SIP 183 session progress” message. However, the session information including the session identifier for the media control protocol is not inserted in the “SIP 183 session progress” message. According to the fourth example, the session information including the session identifier for the media control protocol is inserted in an “SIP PRACK” message which acknowledges the “SIP 183 session progress” message.

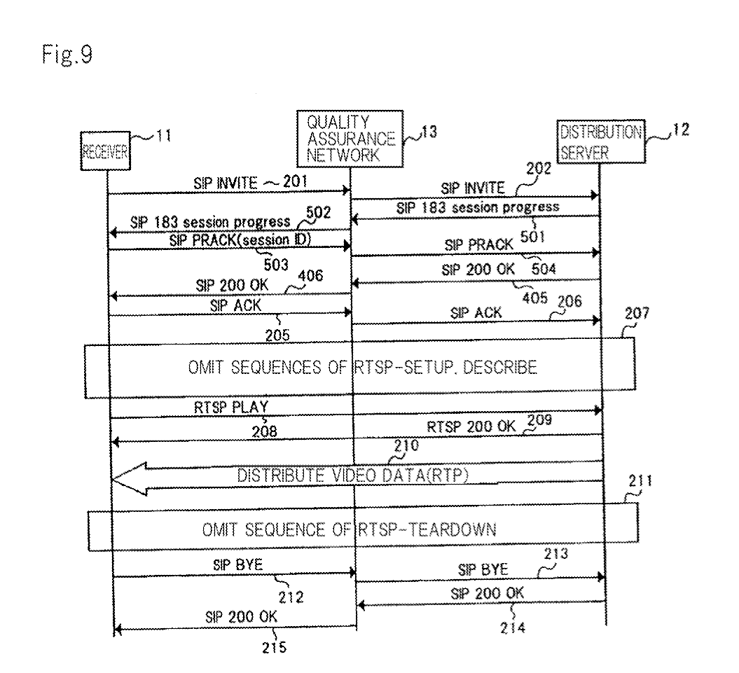

FIG. 9 is a sequence diagram showing an operation sequence of a communication system according to the fourth example. Distribution server 12 which has received the “SIP INVITE” message sends an “SIP 183 session progress” message as a tentative response to quality assurance network 13 (step 501). Having received the “SIP 183 session progress” message, quality assurance network 13 sends the “SIP 183 session progress” message to receiver 11 (step 502).

Having received the “SIP 183 session progress” message, receiver 11 returns an “SIP PRACK” message acknowledging the tentative response to quality assurance network 13 (step 503). The session information including the session identifier for the media control protocol is inserted in the “SIP PRACK” message. Quality assurance network 13 which has received the “SIP PRACK” message sends the “SIP PRACK” message to distribution server 12 (step 504). Subsequently, the operation sequence is identical to the operation sequence according to the third example shown in FIG. 8 (steps 405, 406, 205 through 215).

### Fifth Example

According to a fifth example, as with the first example, it is assumed that SIP is used as the session control protocol, RTSP as the media control protocol, and RTP as the media distribution protocol. According to the fifth example, furthermore, it is assumed that after distribution server 12 has communicated with receiver 11 according to SIP and confirmed that both distribution server 12 and receiver 11 are capable of accepting messages, distribution server 12 determines a final session identifier for the media control protocol.

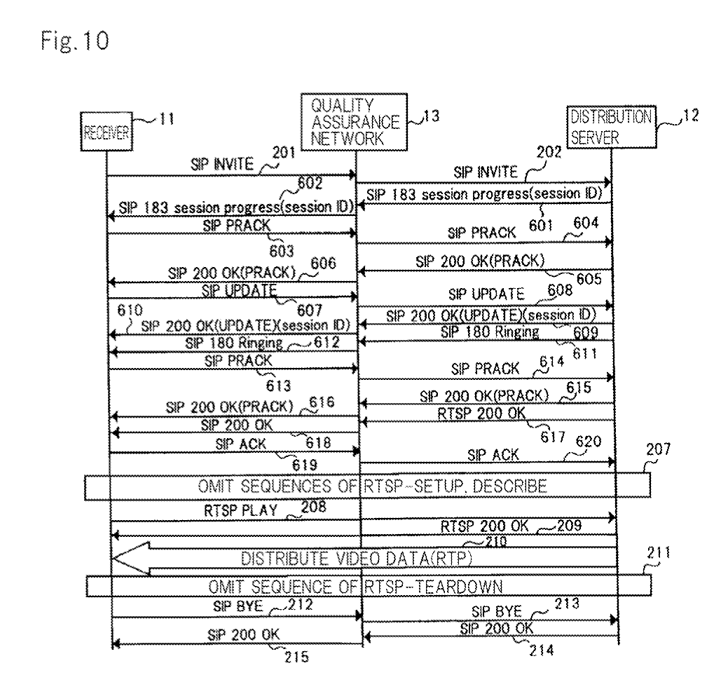

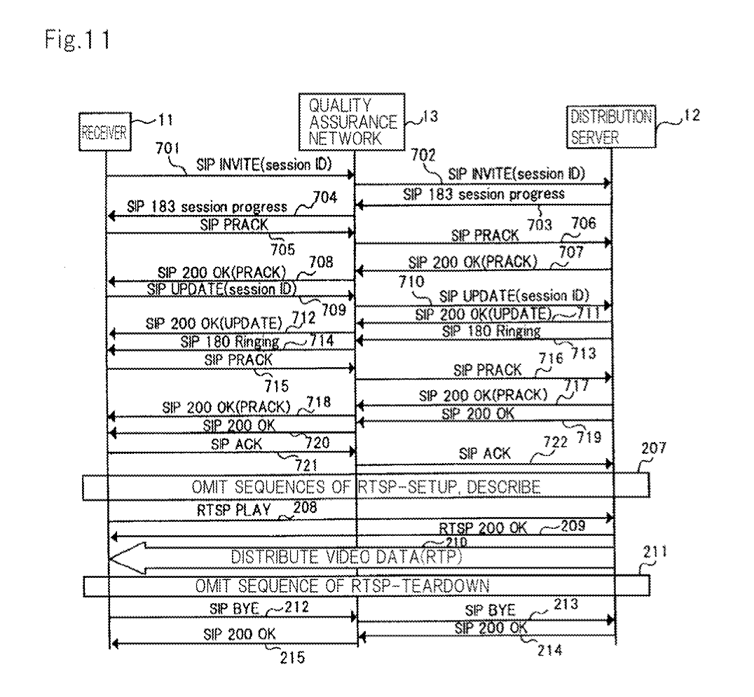

FIG. 10 is a sequence diagram showing an operation sequence of a communication system according to the fifth example. Distribution server 12 which has received the “SIP INVITE” message from quality assurance network 13 sends an “SIP 183 session progress” message to quality assurance network 13 (step 601). The session identifier for the media control protocol, which has been selected by distribution server 12, is inserted in this message. Quality assurance network 13 which has received the “SIP 183 session progress” message sends the “SIP 183 session progress” message in which the session identifier for the media control protocol is inserted to receiver 11 (step 602).

Thereafter, receiver 11 indicates to distribution server 12 whether or not it can accept a candidate for the session identifier selected by distribution server 12, and, if necessary, updates the session identifier (steps 603 through 610). The session identifier for the media control protocol is determined according to an agreement between receiver 11 and distribution server 12, and distribution server 611 extracts video data (steps 611 through 616).

After distribution server 12 has extracted video data, the establishment of a session is completed when triggered by a response from distribution server 12 (steps 617 through 620). Subsequently, the operation sequence is identical to the operation sequence according to the first example shown in FIG. 6 (steps 207 through 215).

According to the present example, receiver 11 determines whether or not it can accept the session identifier selected by distribution server 12, and indicates the determined result to distribution server 12. However, the present invention is not limited to such a sequence. Instead, a session identifier to be actually used may be determined while distribution server 12 and receiver 11 are indicating a session identifier that they can accept to each other.

According to the present example, distribution server 12 indicates that it is extracting video data to receiver 11 with an “SIP 180 Ringing” message. However, the present invention is not limited to such an example, but the “SIP 180 Ringing” message in steps 713, 714 may be omitted.

### Sixth Example

According to a sixth example, contrary to the fifth example, after receiver 11 has communicated with distribution server 12 according to SIP and confirmed that both distribution server 12 and receiver 11 are capable of accepting messages, receiver 11 determines a final session identifier for the media control protocol.

FIG. 11 is a sequence diagram showing an operation sequence of a communication system according to the sixth example. Receiver 11 sends an “SIP INVITE” message in which the session information including the session identifier for the media control protocol, selected by receiver 11, is inserted to quality assurance network 13 (step 701). Having received the “SIP INVITE” message, quality assurance network 13 sends the “SIP INVITE” message in which the session information including the session identifier is inserted to distribution server 12 (step 702).

Thereafter, distribution server 12 indicates to receiver 11 whether it can accept a candidate for the session identifier selected by receiver 11 or not, and, if necessary, updates the session identifier (steps 703 through 712). The session identifier for the media control protocol is determined according to an agreement between receiver 11 and distribution server 12, and distribution server 611 extracts video data (steps 713 through 716).

After distribution server 12 has extracted video data, the establishment of a session is completed when triggered by a response from distribution server 12 (steps 719 through 722). Subsequently, the operation sequence is identical to the operation sequence according to the first example shown in FIG. 6 (steps 207 through 215).

Receiver 11 according to the above exemplary embodiment and examples may be realized by having a computer execute a software program which is descriptive of the operation of session control protocol executor 21, media control protocol executor 22, and media distribution protocol executor 23.

Distribution server 12 according to the above exemplary embodiment and examples may also be realized by having a computer execute a software program which is descriptive of the operation of session control protocol executor 31, media control protocol executor 32, and media distribution protocol executor 33.

The present invention has been described above in reference to the exemplary embodiment and examples. However, the present invention is not limited to the exemplary embodiment and examples. Rather, changes that can be understood by those skilled in the art within the scope of the invention may be made to the arrangements and details of the present invention which are defined by the claims.

The present application claims priority based on Japanese patent application No. 2007-268851 filed on Oct. 16, 2007, and incorporates herein the entire disclosure thereof by reference.

1. A communication system for transferring data through a quality assurance network which is capable of making quality settings for each session, comprising:
a first communication apparatus that executes a session control protocol thereby to determine a session identifier which identifies a session for media-related protocols for transferring said data when the session is established, and thereafter executes said media-related protocols thereby to perform communications for transferring said data on said session; and
a second communication apparatus that executes said session control protocol thereby to establish a session for said media-related protocols with said first communication apparatus, and thereafter executes said media-related protocol thereby to perform communications for transferring said data with said first communication apparatus on said session.

2. A communication system according to claim 1, wherein said media-related protocols include a media distribution protocol for distributing said data and a media control protocol for controlling the distribution of said data; and
said first communication apparatus determines a session identifier of a session for at least said media control protocol when said session is established by executing said session control protocol.

3. A communication system according to claim 2, wherein said media control protocol comprises Session Initiation Protocol, said media distribution protocol comprises Real Time Transport Protocol, and said media control protocol comprises Real Time Streaming Protocol, said Real Time Streaming Protocol being implemented in Transmission Control Protocol.

4. A communication system according to claim 2, wherein said media-related protocols also include one or both of an error correcting protocol and a quality of service report protocol.

5. A communication system according to to claim 1, wherein when the session for said media-related protocols is established by executing session control protocol, said first communication apparatus and said second communication apparatus send and receive session information including said session identifier, which is required to start the communications according to said media-control protocols, thereby bringing said media-control protocols into a state capable of immediately starting the communications.

6. A communication system according to claim 5, wherein the state of said media-control protocols transits when triggered by operation of either one of said session control protocol and said media-related protocols.

7. A communication system according to claim 1, wherein either one of said first communication apparatus and said second communication apparatus comprises a distribution server for distributing said data and the other thereof comprises a receiver for receiving said data from said distribution server; and
wherein said distribution server distributes said data to said receiver when said distribution server and said receiver perform the communications according to said media-control protocols for transferring said data on said session.

8. A communication system according to claim 7, wherein said distribution server distributes said data to said receiver by way of multicast transmission.

9. A communication system according to claim 7, wherein said video data distributed from said distribution server to said receiver include video data, and said receiver reproduces the data which are received thereby.

10. A communication system according to claim 1, wherein when said first communication apparatus and said second communication apparatus are in a state capable of controlling the session while specifying said media-related protocols by determining said session identifier, said first communication apparatus and said second communication apparatus make quality settings about the session for said media-related protocols prior to starting the communications according to said media-related protocols.

11. A communication system according to claim 1, wherein while the session for said media-related protocols is being maintained, the session identifier of said session is managed either one or some or all of said first communication apparatus, said second communication apparatus, and said quality assurance network.

12. A communication system according to claim 1, wherein either one or both of said first communication apparatus and said second communication apparatus comprise one or plural apparatus, and said session control protocol and said media-related protocols are executed by said one or plural apparatus.

13. A communication system according to claim 1, wherein said first communication apparatus communicates with said second communication apparatus according to said session control protocol thereby to confirm that both said first communication apparatus and said second communication apparatus can accept messages and thereafter determines a final session identifier.

14. A communication method in a communication system for transferring data through a quality assurance network which is capable of making quality settings for each session, comprising:
executing a session control protocol thereby to determine a session identifier which identifies a session for media-related protocols for transferring said data when the session is established; and
thereafter executing said media-related protocols thereby to perform communications for transferring said data on said session.

15. A communication apparatus for sending or receiving data in a communication system for transferring said data through a quality assurance network which is capable of making quality settings for each session, comprising:
session control protocol executing unit executes a session control protocol thereby to determine a session identifier which identifies a session for media-related protocols for transferring said data when the session is established; and
media-related protocols executing executes said media-related protocols after said session control protocol executing unit has determined said session identifier, thereby to perform communications for transferring said data on said session.

16. (canceled)
